(19) United States
(12) Patent Application Publication
(10) Pub. No.: US 2017/0118966 A1
(43) Pub. Date: May 4, 2017

(54) Collapsible Floating Fishing Net

(71) Applicant: Nicholas Mark Wiltz, Hood River, OR (US)

(72) Inventor: Nicholas Mark Wiltz, Hood River, OR (US)

(21) Appl. No.: 14/930,024

(22) Filed: Nov. 2, 2015

(51) Int. Cl. A01K 71/00

(52) U.S. Cl. CPC A01K 71/00; A01K 2227/40

(57) ABSTRACT

A stowable, collapsible floating waterproof fishing net that may be employed at the surface of a body of water to retain marine life, or any article in the water, adjacent and outside of a water craft, vessel or person. It has a flexible, upper floatable ring that forms a concave well below the surface with the attached fabric. The ring twistably contorts or coils and stacks upon itself going from a hoop to a stacked coil configuration, so as to reduce the volume of the net when collapsed, approximately 50 fold from its enclosable, opened volume and its surface area by more than 12 fold. It generally utilizes an opaque fabric flange extending from the floatable ring into the concave well to obstruct the entrapped marine life's vision and the diffracted surface light so as to drive the marine life to the bottom of the well, therein reducing their opportunity to escape by leaping over the ring.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention relates to a floatable enclosure that may be employed at the surface of a body of water to retain marine life or any article desired, adjacent and outside of a water craft or vessel or a wader clad fisherman in the water.

Watersports have evolved dramatically over the last few decades with the advent of jet skis, personal watercraft, sailboards, sit atop kayaks and canoes, powered surfboards, fishing float chairs, huge personal inflatable tubes, and paddle boards. The wave of current watersports rides upon the concept of compact watercraft that allows a plethora of different activities to be conducted therefrom. These include, fishing, transportation, towed motion sports, general leisure, and the like. Unfortunately, because of their limited size and amount of storage thereon, often items cannot be reasonably, comfortably or even safely stored on these compact watercraft. In the situation of a foot fisherman, storage room and mobility is also limited, as in the case or walking thru shore-side brush, weeds, foliage or timber. Other situations do not lend themselves to storage even when there is ample room. Items that extend into the air are caught by the force of the wind, and with enough wind forced exerted, can cause a kayak, canoe, float tube or raft to excessively drift in an undesirable direction and and/or speed. A large fishing net for example that is used for fishing needs to be stored. Such an example is encountered when one fishes from a kayak, paddleboard or float chair. Any captured marine life retains its freshness (and liveliness, health and vigor) if kept in the water, and the transfer of any smell onto the water craft can also be minimized. However when fish are kept in a net with its top boundary at the surface of the water, they can escape by jumping out of the net. In the case of general leisure, often a beverage/flying disk/ball or the like, creates more room on the craft if it is stored off of the craft, floating in the water.

Henceforth, a device for the floatable retention of items kept overboard from, but adjacent to a compact watercraft or person that allows for the quick retrieval of the items therefrom, and that could be stored in a compact fashion would fulfill a long felt need in the watersport (or fishing) industry. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a portable, physically compressible, floatable, waterproof, open topped storage net that is able to be easily stored. Optionally incorporated into an alternate embodiment, is series of retention straps to retain the net in its storage configuration.

It has many of the advantages mentioned heretofore and many novel features that result in a new floatable storage net which is not anticipated, rendered obvious, suggested, or even implied by any of the prior art, either alone or in any combination thereof.

In accordance with the invention, an object of the present invention is to provide an improved floating storage net capable of expanding upon opening to at least 50 times its collapsed volume.

It is another object of this invention to provide a lightweight, collapsible fishing net capable of floating with its topmost boundary on the surface of the water, yet preventing fish from escaping.

It is a further object of this invention to provide an improved fishnet with a minimal of structural components to reduce the cost of fabrication.

It is yet a further object of this invention to provide an improved floating fishnet that is designed for simple collapsible storage, wherein the reduction in volume and area is substantial.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front side perspective view of the collapsible, floating fishing net

FIG. 2 is a side view of the fishing net;

FIG. 3 is a top view of the fishing net;

FIG. 4 is a rear view of the fishing net showing the compaction strap;

FIG. 5 is a cross sectional view of the fishing net showing the floating ring and fabric attachments;

FIG. 6 is a side view of an alternate embodiment of the fishing net with a single panel concave enclosure design;

FIG. 7 is a side view of an alternate embodiment of the fishing net with a multi panel concave enclosure design; and

FIGS. 8 a-f are sequential illustrations of the folding steps to compact the fishing net.

### DETAILED DESCRIPTION

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

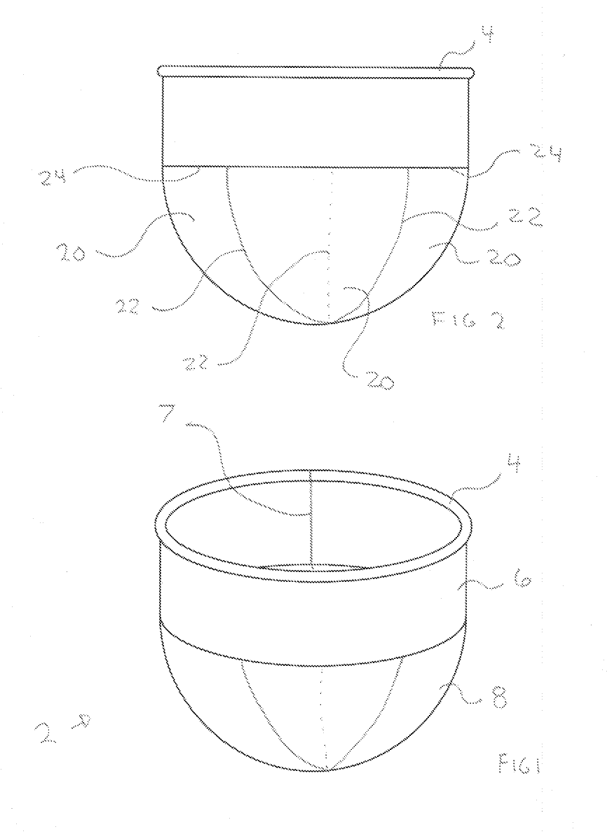

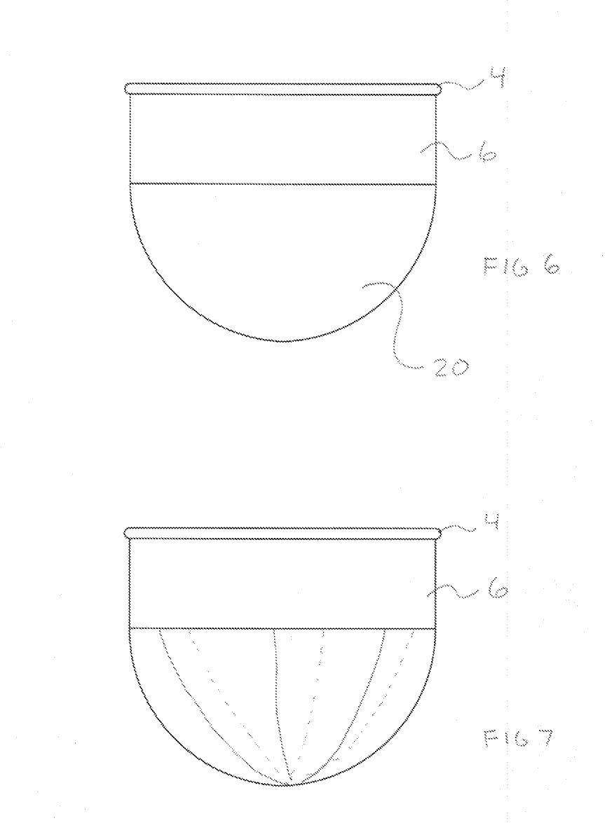

Looking at FIGS. 1-4 it can be seen that the collapsible, floating fishing net 2 has but four parts: a floatable (water buoyant), twistable ring 4; an opaque, fabric retention flange 6; a fabric retention barrier 8; and an adjustable compaction strap 10. The ring 4 floats on the surface of the water and the retention flange 6/retention barrier 8 assembly forms a concave well that is denser than water so that it sinks to extend below the surface, terminated at its top perimeter by the ring 4. It is this well that holds the marine life (or objects that you may want to retain, as in its use when skin diving; your tools, your beer, etc.) The ring 4 has a density less than water and the materials used for the well have densities greater than water. In this way, the ring 4 floats and the well sinks. (In an alternate embodiment there may be a small pocket at the center of the bottom of the well to accept a dense abject, such as a lead fishing sinker, to facilitate the sinking of the well portion of the net.) Looking at FIG. 5 it can be seen that in the preferred embodiment, the ring 4 is a section of polymer tubing 12 of a closed foam cell construction with a rectangular flexible member 14 running through the approximate center of the polymer tubing 12. The ring 4 is round or ovular in cross sectional although other cross sectional configurations may be employed. (When the ovular shape is it used it has a major diameter approximately one half of minor diameter.) The flexible member 14 in the preferred embodiment is a solid polymer rod (preferably fiberglass however it may be made of other materials such as steel, wood, etc.) with a rectangular cross section although it is well known that other cross sectional configurations may be employed such as oval, round, square, and that the flexible member need not be solid but could be of a hollow, tubular construction, The critical properties of the ring's material selection is that it the combination must be less dense than water and elastically deformable over the range of physical manipulations for storage that allows for two figure eight twists and two 90 degree folds to be made at the waist of the figure eights in the ring without any permanent deformation encountered. This allows for an extensive reduction in size for storage. In the preferred embodiment the 29 Inch diameter ring is capable of twisting in on itself three times to form an 11 inch stacked ring so as to give a reduction in surface area from approximately 616 square inches to approximately 50 square inches. The ring 4 must also have an overall water buoyancy. The flexible member 14 generally will have a bias for linearity and with its proximal and distal ends connected, is tensioned into a generally circular configuration. Thus, when the ring 4 is released from its compacted state, it springs into a tensioned loop.

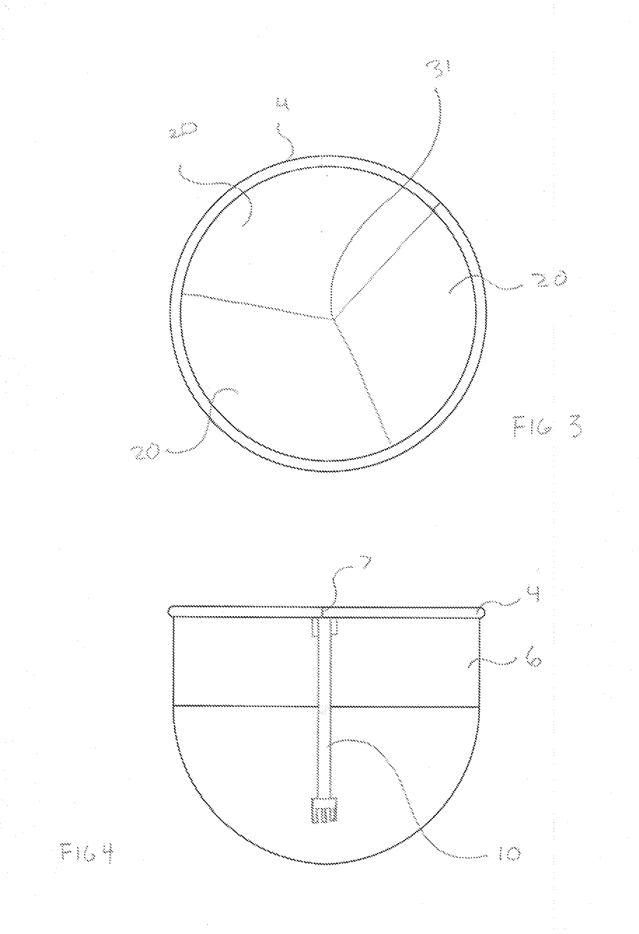

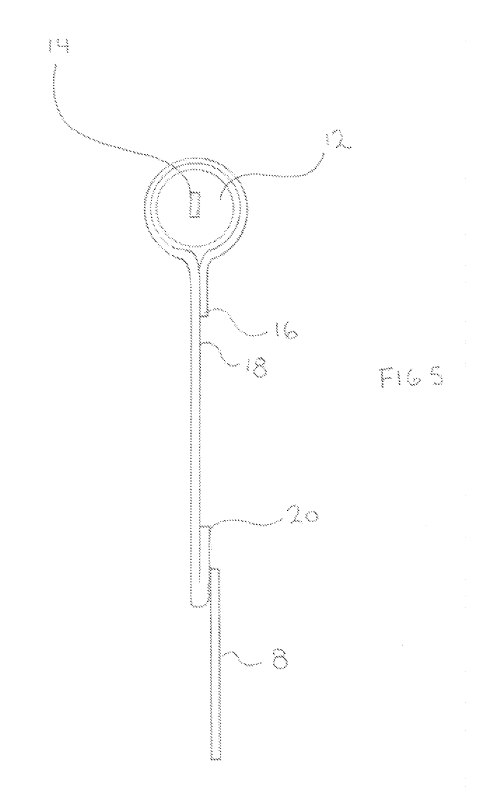

Looking at FIGS. 2 and 4, side views of the net 2 it can be seen that the retention flange 6 acts as the intermediary member and connection element between the ring 4 and the retention barrier 8. The flange 6 is a rectangular planar section of flexible fabric that has a density greater than water. In the preferred embodiment it is approximately 10 inches wide by 89 inches long and its ends are connected so as to form a unitary loop at seam line 7 Looking at FIG. 5 it can be seen that the proximate circumferential edge 16 encircles the complete outer surface of the ring 4, is folded back onto itself and is affixed to the inner face of the flange 18. The remaining material of the flange 6 extends approximately eight inches below the ring 4 from which it extends. Its distal circumferential edge 20 is folded back onto itself and is affixed to fabric retention barrier 8 such that a concave well is formed with the retention flange 6 and retention barrier 8.

The retention barrier 8 has a density also greater than water. In the preferred embodiment the retention flange 6 is made of an opaque, polymer material such as nylon. The two connections between the retention flange 6 and itself may be mechanical such as stitching, seam welding, or chemical such as gluing. The connection between the retention flange 6 and retention barrier 8 is similarly affixed.

The opaque flange 6 serves the dual purpose of both minimizing diffracted sunlight from the water's surface entering the top vertical portion of the well, and from blocking outward visibility into the surrounding water from the top vertical portion of the well. These two mechanisms result in driving the enclosed fish deeper into the concave well (where their perceived visibility is increased) and preventing them from jumping out of the net.

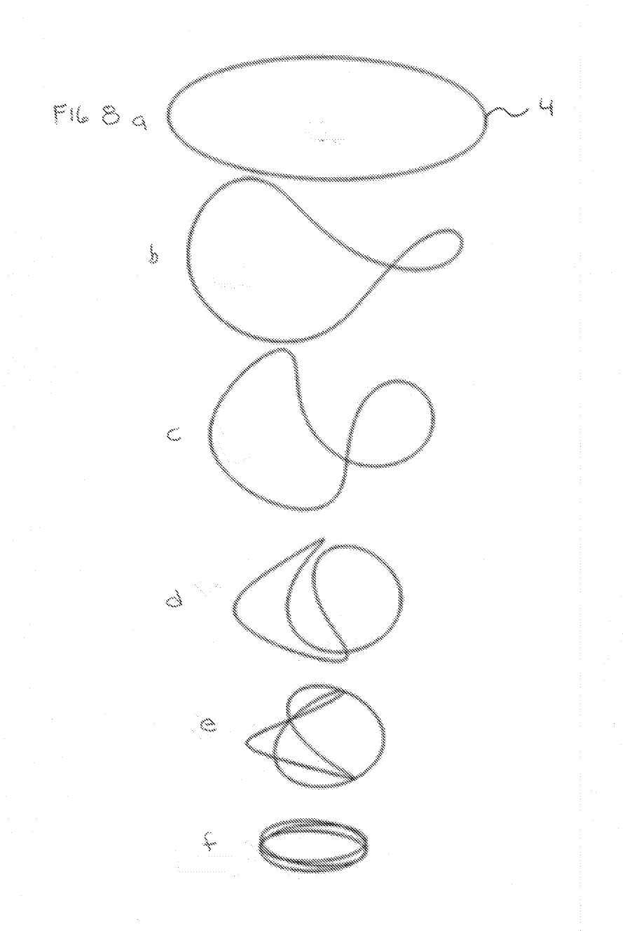

The retention barrier 8 serves the purposes of allowing visibility from in the well, allowing the unhindered transfer of water in and out of the well, and facilitating the draining of the net 2 when raised from the water. FIG. 2 shows that generally, the barrier 8 is made of a series of polymer fabric mesh panels 20 affixed to each adjacent panel about their side perimeter edges 22. In the preferred embodiment there are three “V” shaped mesh panels with two of their side perimeter edges 22 joined to the adjacent panel 20 and their remaining top perimeter edge 24 affixed to the retention flange 6. It is well known in the art that there are a plethora of other panel configurations that can also be employed. FIG. 6 shows a single panel design while FIG. 7 shows a six panel design. The size of the orifices in the nest may vary depending upon the purpose of the fishing net. Smaller orifices will be used if the net 2 is intended to hold bait such as minnows and larger orifices are suitable for larger marine life.

When the net 2 is in its operable mode (open and in water), the well is fully submersed because of its density and the ring 4, tensioned into a generally circular configuration, floats on the surface. The net 2 has a storage collapsed size of approximately 9 inches round by 2 inches deep and an open exterior size of 29 inches around with a 1 inch diameter ring 4 and a 24 inch deep netted well. There is only a unitary strip of fabric used for the retention flange 6 and three netting (mesh) panels used for the retention. The opaque retention flange 6 extends downward from the ring 4 about one third of the depth of the concave enclosure. (In the preferred embodiment this represents approximately eight inches.) The polymer mesh is fabricated from three “V” shaped panels 29 inches across the top (horizontal) perimeter edge 24, and 21 inches across the side (vertical) perimeter edge 22. The identical panels 20 are arranged in a ring wherein the shorter vertical, perimeter edges 22 of adjacent panels are mechanically attached and the longer horizontal side of each panel is mechanically affixed to the bottom edge of the flange 6. In this way the apex at the intersection of each panel's two shorter vertical edges 22 is connected to the identical vertexes of the other two panels and resides at the approximate midpoint 31 of the bottom of the well formed. (FIG. 3)

In the preferred embodiment the area of the open ring 4 in its operable mode is approximately 616 square inches and the ring 4 when collapsed is approximately 50 square inches.

Collapsed, it has a depth of 2 inches and a volume of 100 cubic inches. Open its enclosable volume is 5153 cubic inches. The ring is oval measuring one inch by one half inch. The ring is capable of twisting in on itself 3 times to give a reduction in surface area from 616 square inches to 50 square inches. This corresponds to an approximate 52 fold reduction in volume from the open capacity of 2.98 cubic feet to 0.057 cubic feet and a 12 fold reduction in area.

Looking at FIGS. 8 a-f, it can be seen that the following procedure to fold the net into a triple coil is used:

The circular ring of the net (8 a) is grasped in two hands at the 2 o'clock and the 10 o'clock positions;

The grasped points are brought toward the center of the ring until a taco-like configuration (8 b and c) is made such that your palms face each other;

Change your grip so your hands can continue rotating into the folding motion;

Bring what used to be the top of the net down into the center of the net (8 d); and

Using your wrists and forearms, move the two side rings that have formed into the middle (8 e and f).

After the triple coil is formed, and any exposed fabric retention barrier is tucked between the coils, strap 10 is positioned around the stacked array of loops, and connected while the stacked array is slightly deformed (momentarily) into an oval or elliptical form then allowed to return to its circular configuration. (FIG. 8 f) When in its compacted state, the net 2 is under tension from the spring force of the rod 14.

The ring 4 being elastically deformable with a spring memory allows the net 2 to spring into its open configuration for use in its operable mode. The compaction strap 10 is a strap fastener with one end of a matingly connectable two piece buckle affixed at the distal and proximate ends of the strap. The proximate end of the strap is mechanically affixed at any point around the exterior perimeter of the top of the flange 6. (i.e. where the where the flange 6 is affixed to itself about the ring 4.) It is approximately 20 inches in length. At the loose end (distal end) of the strap 10 there is also a hook style connector affixed.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A collapsible fishing enclosure for use on the surface of a body of water, comprising:
a floatable ring having an outer surface; and
a concave enclosure having an upper end and a lower end and defining a net depth and a first volume;
wherein said upper end of said enclosure is affixed about said outer surface of said ring and when an operable mode, said enclosure extends therefrom said ring below said surface of the body of water.

2. The collapsible fishing enclosure of claim 1 further comprising a compaction strap affixed to said enclosure to hold said fishing enclosure in a tensioned, compacted state defining a second volume.

3. The collapsible fishing enclosure of claim 1 wherein said concave enclosure is formed from a fabric flange and at least one fabric panel, said fabric flange having a proximal edge affixed to said ring and a distal edge affixed to said fabric panel.

4. The collapsible fishing enclosure of claim 3 wherein said fabric flange is opaque.

5. The collapsible fishing enclosure of claim 4 wherein said fabric flange fully encases said outer surface of said ring and has a density greater than water.

6. The collapsible fishing enclosure of claim 1 wherein said floatable ring is a water buoyant tube with a circular tensioned flexible member therein.

7. The collapsible fishing enclosure of claim 3 wherein said floatable ring is a water buoyant tube with a circular flexible member in tension therein.

8. The collapsible fishing enclosure of claim 4 wherein said floatable ring is a floatable polymer tube with a flexible member in circular tension therein.

9. The collapsible fishing enclosure of claim 5 wherein said floatable ring is a floatable polymer tube with a flexible member in circular tension therein.

10. The collapsible fishing enclosure of claim 3 wherein the number of said fabric panels is three and said fabric panels are a mesh panels

11. The collapsible fishing enclosure of claim 10 wherein said floatable ring is a floatable polymer tube with a flexible member in circular tension therein.

12. The collapsible fishing enclosure of claim 11 wherein said fabric flange is opaque and extends approximately one third of the depth of the concave enclosure.

13. The collapsible fishing enclosure of claim 10 wherein said mesh panels are triangular with three edges, wherein two of said edges are affixed to said edges of adjacent panels and said remaining edge of said panels are affixed to said flange.

14. The collapsible fishing enclosure of claim 13 wherein said floatable ring is a floatable polymer tube with a flexible member in circular tension therein.

15. The collapsible fishing enclosure of claim 14 wherein said fabric flange is opaque.

16. The collapsible fishing enclosure of claim 15 wherein said fabric flange projects at approximately 90 degrees, from a plane of said floatable ring so as to extend downward from said surface of a body of water when in an operable mode.

17. The collapsible fishing enclosure of claim 16 wherein said fabric flange extends to approximately one third of said net depth.

18. The collapsible fishing enclosure of claim 2 wherein said first volume is approximately 50 times greater than said second volume.
